(19) United States
(12) Patent Application Publication
(10) Pub. No.: US 2003/0209374 A1
(43) Pub. Date: Nov. 13, 2003

(54) Compressed gas augmented drive system and method

(76) Inventor: Francis Anthony Gallo JR., Scottsdale, AZ (US)

Correspondence Address: WEISS & MOY PC, 4204 NORTH BROWN AVENUE, SCOTTSDALE, AZ, 85251, US

(21) Appl. No.: 10/395,465

(22) Filed: Mar. 20, 2003

Related U.S. Application Data
(60) Provisional application No. 60/365,520, filed on Mar. 20, 2002.

(51) Int. Cl. B60K 1/00

(52) U.S. Cl. 180/65.2; 180/302

(57) ABSTRACT

A gas augmented drive system and method for a hybrid electric vehicle. The system and method utilizes compressed gas to turn a turbine, the rotation of which generates power that can be used, among other things, to power the vehicle batteries and/or power a secondary electrical system.

### RELATED APPLICATION

This non-provisional application claims priority from provisional application No. 60/365,520, filed on Mar. 20, 2002.

### FIELD OF INVENTION

This invention relates generally to drive systems and methods and, more specifically, to a gas augmented drive system and method which, in a preferred embodiment, is for a hybrid electric vehicle.

### BACKGROUND OF THE INVENTION

In light of concerns over dwindling oil reserves and pollution, interest in electric vehicles is increasing. Major automakers have released, within the last several years, fully-electric as well as hybrid gas-electric vehicles. Yet these types of vehicles still represent only a very small minority of all vehicles sold.

Among the barriers to greater acceptance of electric vehicles has been concern about their range between battery charges. The hybrid vehicle addresses this issue by providing an internal combustion engine which can provide recharging power to the batteries. However, the addition of an internal combustion engine implicates those same issues, albeit at a lower level, discussed above—dwindling oil reserves and pollution.

A need therefore existed for a drive system and method for an electric vehicle which can extend the range between battery charge, yet preferably without resort (or at least with diminished reliance upon) an internal combustion engine. The drive system and method should, preferably, not increase vehicle emissions, and instead should rely on a power source that is or at least approaches zero emissions.

The present invention satisfies these needs and provides other, related, advantages.

### SUMMARY OF THE INVENTION

It is an object of the present invention to provide a drive system and method for an electric vehicle which can extend the range between battery charge, without resort (or at least with diminished reliance upon) an internal combustion engine.

It is a further object of the present invention to provide a drive system and method for an electric vehicle that does increase vehicle emissions, and instead relies on a power source that is or at least approaches zero emissions.

### BRIEF DESCRIPTION OF THE PREFERRED EMBODIMENTS

In accordance with one embodiment of the present invention, a * is disclosed. The

### BRIEF DESCRIPTION OF THE DRAWINGS

FIG. 1 is a block diagram of an embodiment of the compressed gas augmented drive according to the present invention.

FIG. 2 is perspective view of an embodiment of the compressed gas driven turbine with a compressed gas supply system according to the present invention.

FIG. 3 is an end, cross-sectional view of the compressed gas driven turbine with a compressed gas supply system of FIG. 2.

FIG. 4 is a simplified flow chart illustrating the operation of an embodiment of the compressed gas augmented drive according to the present invention.

FIG. 5 is a perspective view of an embodiment of the compressed gas augmented drive according to the present invention.

### DETAILED DESCRIPTION OF THE PREFERRED EMBODIMENTS

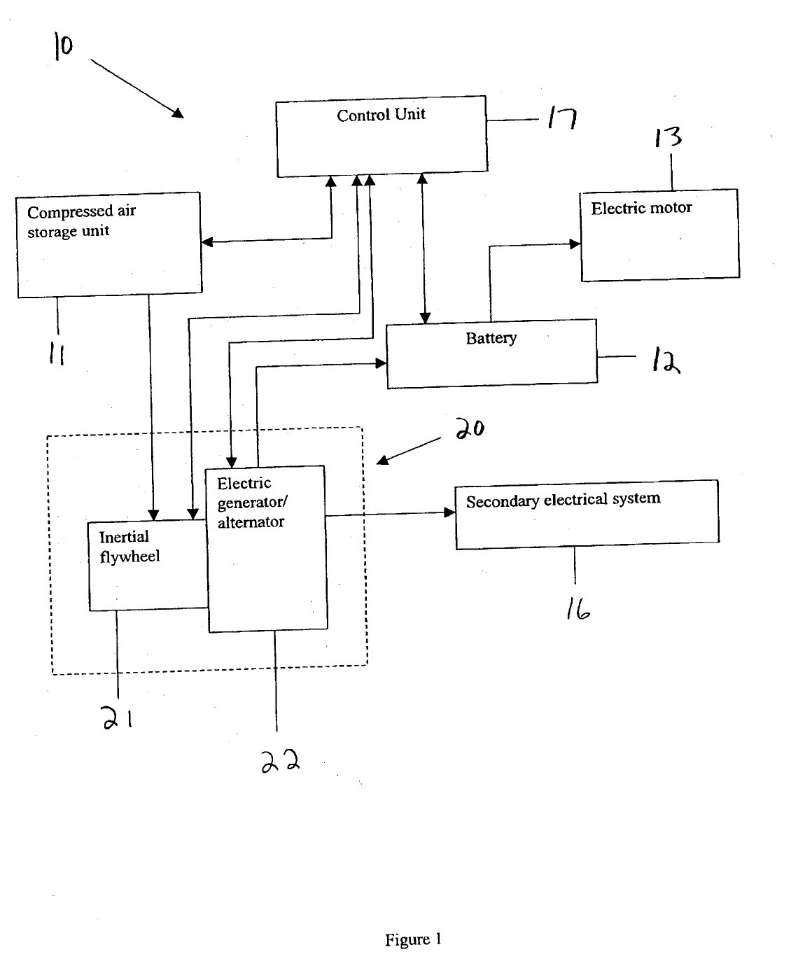

Referring to FIG. 1, an embodiment of a compressed gas augmented drive 10 for a hybrid electric vehicle according to the present invention is shown. At a basic level, the main components of the compressed gas augmented drive 10 include a compressed gas storage unit 11, a compressed gas driven turbine 20, at least one battery 12, an electric motor 13, a secondary electric system 16, and a control unit 17.

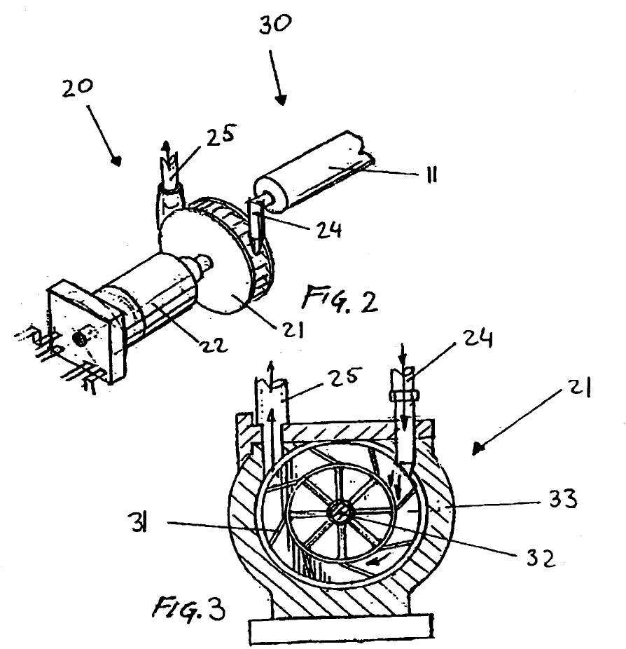

Referring to FIGS. 2 and 3, certain of these components are illustrated. The compressed gas driven turbine 20 consists of an inertial flywheel 21 coupled to an electric generator/alternator 22. In one preferred embodiment, the generator/alternator 22 is a combined starter/generator/alternator. As shown in FIGS. 3 and 5, the inertial flywheel 21 is preferably mounted on an axle 32, covered by a housing 33, and has a plurality of angled blades 31 along the perimeter thereof. (It should be noted that the configurations shown in FIGS. 3 and 5 are only intended to represent examples of a possible configuration of a flywheel useable in the gas augmented drive of the present invention. It should be understood that the term “flywheel” as used herein is intended to encompass any structure capable of being driven by compressed gas with the result that power is produced. It should also be noted that the flywheel could be driven directly by compressed gas as shown herein, or indirectly through a planetary gear system or the like.)

The compressed gas supply system 30 consists of a compressed gas storage unit 11, a compressed gas delivery system 24, and an exhaust 25. As shown in FIG. 5, the compressed gas preferably passes through a compressed gas regulator 23, which regulates the flow of gas from the gas storage unit 11, into the delivery system 24, and into the turbine 20. As shown in FIG. 5, the compressed gas storage unit 11 is preferably an air tank of the type typically used to store compressed air—though other gases, such as helium or nitrogen, could be used—and more than one such gas storage unit 11 can be provided.

It should be noted that the compressed gas storage unit 11 could, in addition to or in place of an air tank(s), also be one or more sealed compartments within the body of the vehicle. By locating gas compartments within the vehicle body, the amount of gas storage can be increased over that possible if only traditional tanks are used. Such compartments may be formed of a plastic material, such as polyethylene or polystyrene, having some deformability. Such a construction can provide the added benefit of increasing vehicle safety, by providing impact attenuation for those portions of the vehicle where gas compartments are located. In this regard, the gas storage unit 11a is intended to be an example of a tank that can be positioned for impact attenuation purposes. Further, referring now to FIG. 5, it is possible to provide a filling valve 27, in either or both the gas storage unit 11 and 11a, so that the compressed gas also can be used to inflate objects, such as the tires of a vehicle or inflatable toys.

As shown in FIGS. 2, 3 and 5, gas is transported from the compressed gas storage unit 11 through the compressed gas delivery system 24, towards the inertial flywheel 21. The compressed gas delivery system 24 includes a compression port (not shown) in order to maximize the pressure inside the housing 33 as the blades 31 pass through the port. The gas is preferably pulse-injected into the housing 33 and onto the blades 31 of the inertial flywheel 21, which pulsing can be regulated by the compressed gas regulator 23 (see FIG. 5). The preferred direction of the compressed gas injection is from the top, as shown in FIGS. 2 and 3, but an injection from the side is also possible. This injection of compressed gas causes the inertial flywheel 21 to turn or, if it is already in motion, to maintain a desired rate or to turn at a higher rate of speed. This results in production (or increased production) of electricity by the electric generator/alternator 22, which converts the kinetic energy of the spinning inertial flywheel 21 into electrical energy. In order to prevent the building up of undue pressure within the housing 33, gas is vented through exhaust 25. (The vented gas (or other byproduct of the release of the gas into the surroundings) can be released as a vehicle exhaust, can be utilized to reduce engine and/or battery temperature, or can be recovered and recycled.) A relief flap (not shown) may also be provided, to vent gas so as to prevent gas pressure within the housing 33 from becoming too high.

To enhance efficiency, there should be minimal tolerance between the blades 31 and the interior of the housing 33, and the area between the blades 31 and interior of the housing 33 should be sealed.

The entire system shown in FIGS. 2 and 5 is preferably mounted on a gimbal mechanism 35, to provide a dynamic sensing purpose. As the vehicle changes plane, the inertial flywheel will resist the change, causing an inertial drag and energy loss. The gimbal 35 mechanism allows the turbine 20 to change plane without resistance and therefor reduces the energy loss through friction.

The electric generator/alternator 22 shown in FIGS. 2 and 5 can be coupled to the battery 12 which powers the electric motor 13. (The term “battery” as used herein is intended to refer to either a single battery or, more likely, to a plurality of batteries used to power an electric motor 13.) In this fashion, the electricity produced may be used to recharge the battery 12, extending vehicle range. Alternatively, the electric generator/alternator 22 shown in FIGS. 2 and 5 can be coupled to the vehicle's secondary electric system 16, which includes the air conditioner, heater, power windows, power door locks, power seats, car stereo, lights, etc. By providing power to the secondary electric system 16, the load on the battery 12 is reduced, again extending vehicle range.

It would also be possible to provide more than one compressed gas driven turbine 20, with one (or more than one) coupled to the battery 12 and one (or more than one) coupled to the secondary electrical system 16. As yet another alternative, the compressed gas driven turbine 20 can be coupled to both the battery 12 and the secondary electrical system 16. A gear type apparatus may also be provided in combination with the turbine 20.

Referring now to FIGS. 1 and 5, the control unit 17 is the brains of the drive 10. It receives and analyzes signals from the electric motor 13, the battery 12, the generator/alternator 22, the inertial flywheel 21, and the compressed gas storage unit 11. Based on the signals received, it can activate the compressed gas driven turbine 20 when needed—for example when the level of the battery 12 falls below a certain level. The introduction of compressed gas into the turbine 20 will be continuously modulated, with more gas being added under high load conditions and less gas being added under low load conditions.

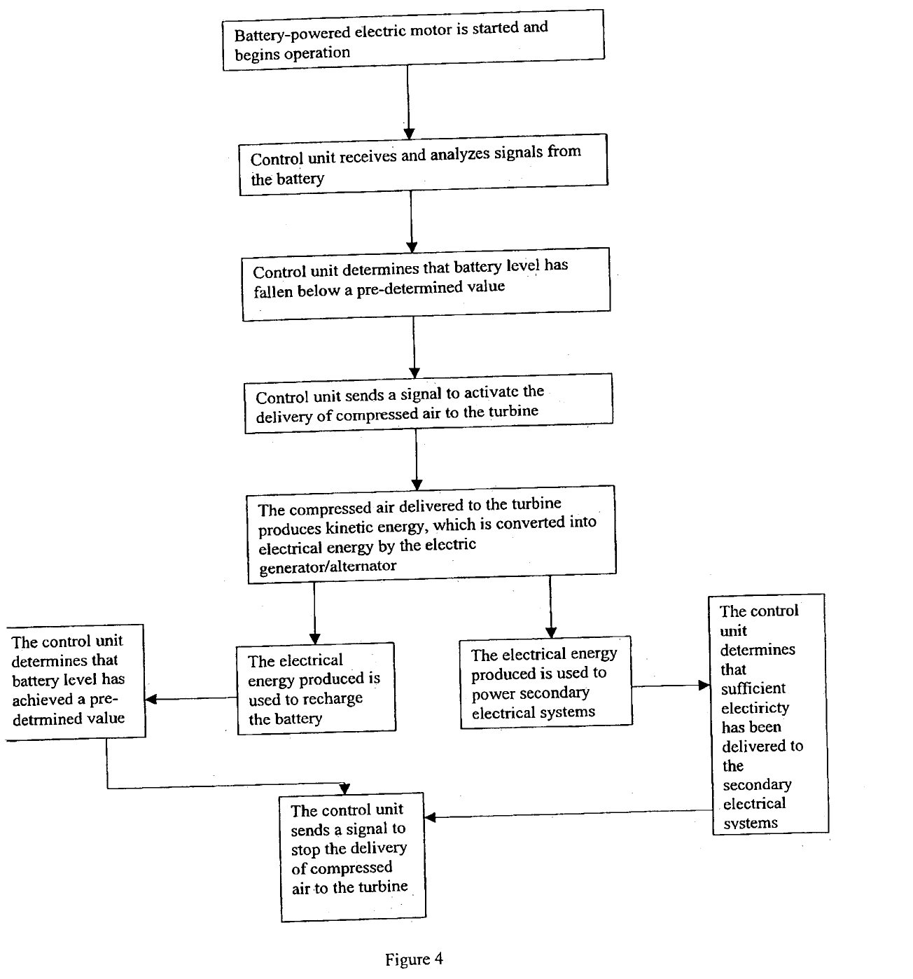

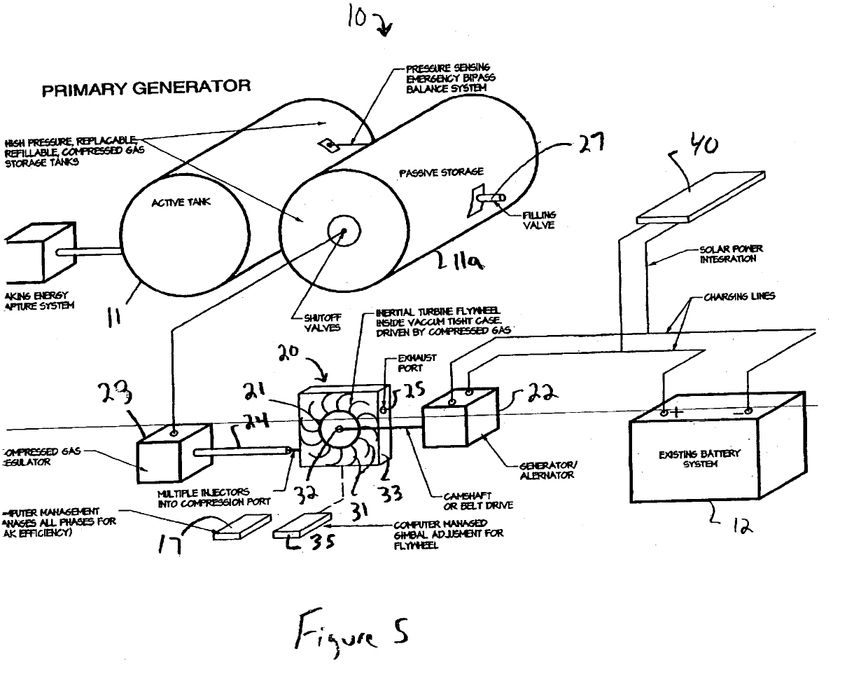

Referring now to FIG. 4, the operation of the compressed gas augmented drive 10 according to the present invention is shown. As the vehicle 10 is operated, the control unit 17 will monitor the different components of the drive 10. When a specified condition is present, an appropriate instruction is sent by the control unit 17 to the relevant system component for action. For example, if the level of the battery 12 falls below a certain value, the control unit 17 will send an instruction to activate the compressed gas storage unit 11. This will result in the delivery of compressed gas to the turbine 20, the production of electricity (or increased production of electricity) by the electric generator 22, and the delivery of that electricity to the battery 12 and/or to the vehicle's secondary electrical system 16. When sufficient electricity has been produced, the control unit 17 will send an instruction ceasing the delivery of compressed gas or reducing its flow. This operation can take place while the vehicle is being operated or while the vehicle is at rest.

In one preferred embodiment, as shown in FIG. 5, the compressed gas augmented drive 10 can be combined with a solar battery 40 assisting the main battery. Using sensors the control unit 17 will detect the input from the solar battery 40 and adjust the input of compressed gas accordingly.

While the invention has been particularly shown and described with reference to preferred embodiments thereof, it will be understood by those skilled in the art that the foregoing and other changes in form and details may be made therein without departing from the spirit and scope of the invention.

For example, while the use of a compressed gas augmented drive has been discussed for a hybrid electric vehicle, such a drive could be used to augment electric motors powering virtually any device—and is not limited solely to use with vehicles. Moreover, while in the preferred embodiment the compressed gas augmented drive replaces the internal combustion engine or other power source used to augment the batteries supplying power to an electric motor, the compressed gas augmented drive could be used in combination with an internal combustion engine—so as to reduce the load on the internal combustion engine and allow it to achieve greater fuel efficiency and improved emissions performance.

I claim:

1. A compressed gas augmented drive system comprising, in combination:
a compressed gas storage unit having compressed gas therein;
a compressed gas driven turbine;
a compressed gas delivery system adapted to deliver said compressed gas from said compressed gas storage unit to said compressed gas drive turbine in a manner that imparts rotational force to said gas driven turbine;
at least one battery in communication with said gas driven turbine;
wherein rotation of said gas driven turbine causes charging of said battery; and
an electric motor powered by said battery.

2. The compressed gas system of claim 1 wherein said compressed gas storage unit is an air tank.

3. The compressed gas system of claim 1 wherein said compressed gas storage unit is a sealed compartment of a vehicle.

4. The compressed gas system of claim 1 wherein said compressed gas driven turbine comprises an inertial flywheel coupled to an electric generator/alternator.

5. The compressed gas system of claim 4 wherein said inertial flywheel is mounted on an axle, covered by a housing, and has a plurality of angled blades along a perimeter thereof.

6. The compressed gas system of claim 1 further comprising an exhaust for said compressed air that has been delivered to said gas driven turbine.

7. The compressed gas system of claim 1 further comprising a control unit adapted to control delivery of said compressed air to said gas driven turbine, wherein said control unit receives and analyzes signals from said electric motor, said battery, said gas driven turbine, and said compressed gas storage unit.

8. The compressed gas system of claim 1 wherein said compressed gas augmented drive system is mounted on a gimbal mechanism.

9. The compressed gas system of claim 1 further comprising a secondary electric system in communication with said electric generator/alternator.
